(19) United States
(12) Patent Application Publication
(10) Pub. No.: US 2007/0268223 A1
(43) Pub. Date: Nov. 22, 2007

(54) Active-matrix organic light emitting diode display

(75) Inventor: Chun-Huai Li, Pingtung (TW)

Correspondence Address: RABIN & Berdo, PC, 1101 14TH STREET, NW, SUITE 500, WASHINGTON, DC, 20005, US

(73) Assignee: AU OPTRONICS CORP., Hsinchu (TW)

(21) Appl. No.: 11/878,135

(22) Filed: Jul. 20, 2007

Related U.S. Application Data
(63) Continuation of application No. 10/628,051, filed on Jul. 28, 2003.

(30) Foreign Application Priority Data
May 12, 2003 (TW) 092112783

(51) Int. Cl. H04M 1/64

(52) U.S. Cl. 345/82

(57) ABSTRACT

An active-matrix organic light emitting diode display. The active-matrix organic light emitting diode display comprises a rectangular pixel unit having an indium tin oxide region disposed therein. The indium tin oxide region has an opening region disposed therein, wherein the opening region is rectangular.

### BACKGROUND OF THE INVENTION

1. Field of the Invention

The present invention relates to an organic light emitting diode (OLED) display, and in particular to an active-matrix organic light emitting diode (AM-OLED) display with increased aperture ratio and illumination.

2. Description of the Related Art

Organic electroluminescent devices or organic light emitting diode (OLED) displays have the characteristics of self-emission and can be arranged in a matrix without requiring a backlight module. Moreover, since the organic light emitting diode (OLED) display is not only thin and light-weight but also has the advantages of high contrast, high resolution, low power consumption, and wide viewing angle. Due to these advantages, it is expected to that OLEDs will be the next generation display device.

Generally, an active-matrix organic light emitting diode (AM-OLED) display is driven by electric current to provide illumination. FIG. 1 is a circuit configuration scheme of a pixel unit in a conventional active-matrix organic light emitting diode (AM-OLED) display. As shown in FIG. 1, a display signal “data line” connects the drain of the first thin film transistor (TFT) T1, and a scan data signal “scan line” connects the gate to switch the first thin film transistor T1 on and off. Furthermore, a voltage drive source V+ connects the drain of the second thin film transistor T2 and the source is connected to the anode of an organic light emitting diode 1. A capacitor 2 is charged keeping a hold voltage to drive the organic light emitting diode 1.

FIG. 2a is a top view of a pixel unit in the conventional active-matrix organic light emitting diode (AM-OLED) display. Generally, at least two thin film transistors are required to drive the organic light emitting diode to illuminate. Referring to FIG. 1 and FIG. 2a, a pixel unit 3 in the conventional active-matrix organic light emitting diode (AM-OLED) display is provided with a first thin film transistor region 41 for receiving the first thin film transistor T1, a capacitor region 42 for receiving the capacitor 2, a second thin film transistor region 43 for receiving the second thin film transistor T2 and an indium tin oxide (ITO) region 5 as the primary illuminating part of the organic light emitting diode 1, wherein the indium tin oxide region 5 includes an opening region 51 and an isolation region 52 enclosing the opening region 51. The isolation region 52 fails to illuminate and the opening region 51 determines the aperture ratio and illumination of the pixel unit 3 because light is primarily emitted through the opening region 51 of the indium tin oxide region 5.

FIG. 2b is a sectional view of c-c′ according to FIG. 2a. As shown in FIG. 2b, an indium tin oxide layer 31 is disposed in the indium tin oxide region 5. The opening region 51 is defined where the indium tin oxide layer 31 contacts the organic illuminating material 32. In. FIG. 2b, a metal layer 34 and the indium tin oxide layer 31 are respectively utilized as anode and cathode such that the organic illuminating material 32 disposed therebetween is electrically driven to illuminate. Additionally, with respect to the isolation region 52, the periphery of the indium tin oxide layer 31 is separated from the organic illuminating material 32 by a silicon nitride (SiN) isolation layer 33.

As active-matrix organic light emitting diode (AM-OLED) displays require at least two TFTs to provide adequate drive current, the TFTs usually occupy a significant proportion of the area of pixel unit 3. Thus, as shown in FIG. 2a, the indium tin oxide region 5 is usually irregularly shaped due to the layout being critically restricted by the arrangement of the TFTs.

To improve the layout and arrangement of the components in a pixel unit, the present invention provides an active-matrix organic light emitting diode (AM-OLED) display capable of increasing the aperture ratio and illumination.

### SUMMARY OF THE INVENTION

An object of the invention is to provide an active-matrix organic light emitting diode display with increased aperture ratio and illumination.

The active-matrix organic light emitting diode display comprises a rectangular pixel unit having an indium tin oxide region disposed therein. The indium tin oxide region has an opening region disposed therein. Particularly, the opening region is rectangular.

Furthermore, with respect to the active-matrix organic light emitting diode display mentioned above, the indium tin oxide region further has an isolation region enclosing the opening region. Moreover, the isolation region in the indium tin oxide region comprises silicon nitride (SiN).

According to the present invention, the opening region is rectangular to improve the layout in a pixel unit such that the aperture ratio and illumination of the display increase.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a circuit configuration scheme of a conventional active-matrix organic light emitting diode (AM-OLED) display;

FIG. 2a is a top view of a pixel unit in the conventional active-matrix organic light emitting diode (AM-OLED) display;

FIG. 2b is a sectional view of c-c′ according to FIG. 2a;

FIG. 3a is a top view of a pixel unit in accordance with the first embodiment of the present invention; and

FIG. 3b is a top view of a pixel unit in accordance with the second embodiment of the present invention.

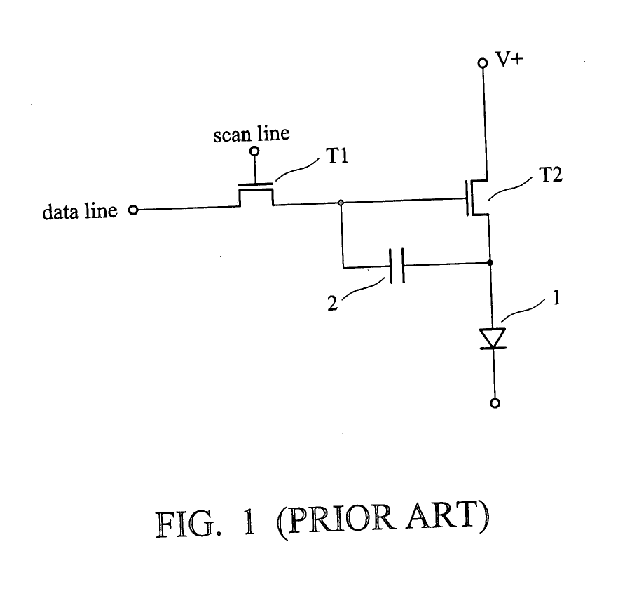

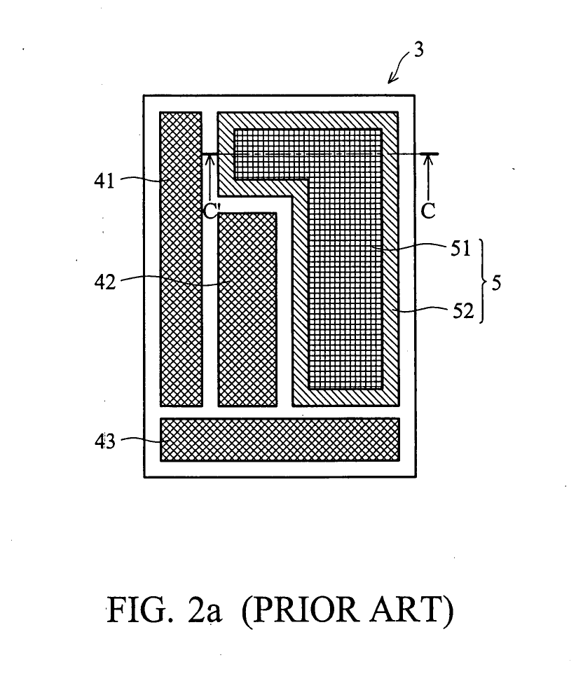

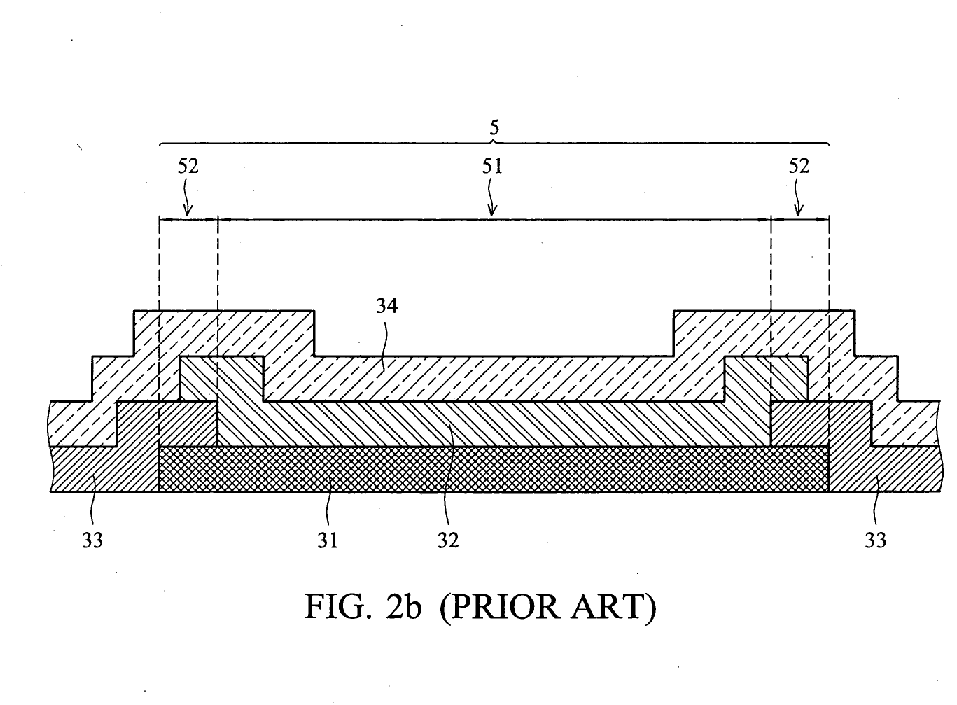

### DETAILED DESCRIPTION OF THE INVENTION

### First Embodiment

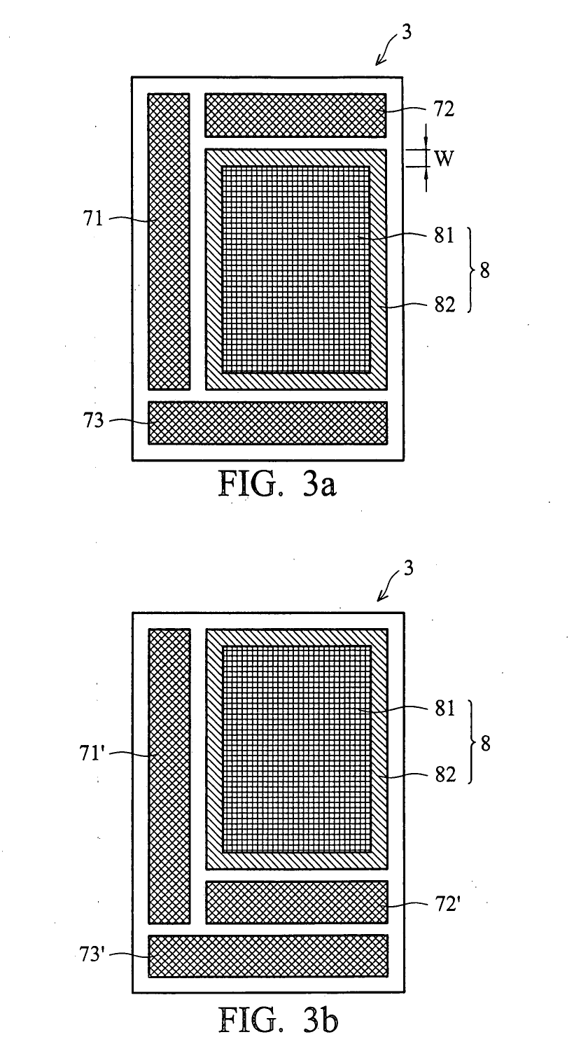

FIG. 3a is a top view of a pixel unit in the active-matrix organic light emitting diode (AM-OLED) display in accordance with the present invention. Referring to FIG. 3a, a pixel unit 3 is provided with a first thin film transistor region 71 disposed at the left side, a capacitor region 72 disposed at the top side, a second thin film transistor region 73 disposed at the bottom side and an indium tin oxide region 8. The first thin film transistor region 71, capacitor region 72 and second thin film transistor region 73 are appropriately arranged around the indium tin oxide region 8 in hoof shape as shown in FIG. 3a such that the indium tin oxide region 8 forms a rectangle occupying the central and right parts of the pixel unit 3.

Furthermore, in FIG. 3a, the indium tin oxide region 8 has an opening region 81 at the center thereof and an isolation region 82 surrounding the indium tin oxide region 8. The efficient illuminating area is the opening region 81 equal to the area of the indium tin oxide region 8 minus the area of the isolation region 82, wherein the area of the isolation region 82 is equal to the perimeter multiplied by the width W (w is about 5 um).

To create as large an efficient illuminating area as possible, it is the object of the present invention to make the opening region 81 an integral shape. Assuming the TFTs and capacitor regions 71, 72, and 73 are constant, the available area of the indium tin oxide region 8 is fixed. According to the geometry and the previously mentioned assumption, assuming the width W is fixed and the indium tin oxide region 8 is rectangular without being concave, the area of the indium tin oxide region 8 increases if the perimeter decreases (maximum area and minimum perimeter occur while the indium tin oxide region 8 is square). Therefore, the present invention makes the indium tin oxide region 8 an integral rectangle without being concave by arranging the TFTs and capacitor regions 71, 72, and 73 in a hoof shape to increase the efficient illuminating area. Opposite to the irregular arrangement of the conventional pixel unit layout mentioned above, the present invention improves the illuminating efficiency of the display with high aperture ratio.

Moreover, the TFTs and capacitor regions 71, 72, and 73 at the sides of the pixel unit 3 can be alternatively exchanged with each other in FIG. 3a to make the indium tin oxide region 8 an integral rectangle. Thus, the efficient illuminating area of the opening region 81 increases with a high aperture ratio to improve the illumination of the display.

### Second Embodiment

FIG. 3b is a top view of a pixel unit in accordance with the second embodiment of the present invention. As shown in FIG. 3b, a pixel unit 3 is provided with a first thin film transistor region 71′, a capacitor region 72′, a second thin film transistor region 73′ and an indium tin oxide region 8. To make the indium tin oxide region 8 an integral rectangle, the TFTs and capacitor regions 71′, 72′, and 73′ are arranged in an L shape. According to this embodiment, the first thin film transistor region 71′, capacitor region 72′ and second thin film transistor region 73′ are respectively disposed at the left side and bottom side. Thus, the indium tin oxide region 8 forms an integral rectangle such that the area of the opening region 81 increases.

As mentioned above, the TFTs and capacitors 71′, 72′, and 73′ at the sides of the pixel unit 3 can be alternatively exchanged with each other to make the indium tin oxide region 8 an integral rectangle. Therefore, the opening region 81 and the aperture ratio increase to improve the illumination of the display.

In summary, the present invention provides an active-matrix organic light emitting diode display increasing the aperture ratio and illumination by arranging the TFTs and capacitor components in a pixel unit such that the indium tin oxide region 8 and the opening region 81 is an integral rectangle. Thus, the isolation region 82 in the indium tin oxide region 8 is minimized to increase the efficient illuminating area of the opening area 81. According to the present invention, the illumination of the display can be efficiently raised due to the high aperture ratio of the opening area 81.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An active-matrix organic light emitting diode display, comprising:
a rectangular pixel unit, comprising a transparent region having a rectangular opening region, a capacitor region, a first TFT region, and a second TFT region, wherein the capacitor region, the first TFT region, and the second TFT region are arranged in a hoof shape or an L shape adjacent to the opening region.

2-3. (canceled)

4. The active-matrix organic light emitting diode display as claimed in claim 1, wherein the transparent region further has an isolation region enclosing the opening region.

5. The active-matrix organic light emitting diode display as claimed in claim 4, wherein the isolation region comprises an insulator film.

6. The active-matrix organic light emitting diode display as claimed in claim 1, wherein the opening region has an organic illuminating material layer and an indium tin oxide layer contacting the organic illuminating material layer.

7. The active-matrix organic light emitting diode display as claimed in claim 6, wherein the rectangular pixel unit further has a metal layer contacting the organic illuminating material layer.

8. The active-matrix organic light emitting diode display as claimed in claim 7, wherein the metal layer is aluminum.

9. An active-matrix organic light emitting diode display, comprising:
a rectangular pixel unit, comprising an active control region and a transparent region having a rectangular opening region, wherein the active control region comprises a capacitor region, a first TFT region, and a second TFT region arranged in a hoof shape or an L shape adjacent to the opening region.

10. The active-matrix organic light emitting diode display as claimed in claim 9, wherein the transparent region further has an isolation region enclosing the opening region.

11. The active-matrix organic light emitting diode display as claimed in claim 10, wherein the isolation region comprises an insulator film.

12. The active-matrix organic light emitting diode display as claimed in claim 9, wherein the opening region has an organic illuminating material layer and an indium tin oxide layer contacting the organic illuminating material layer.

13. The active-matrix organic light emitting diode display as claimed in claim 12, wherein the rectangular pixel unit further has a metal layer on the surface thereof contacting the organic illuminating material layer.
